(19) United States
(12) Patent Application Publication
(10) Pub. No.: US 2013/0218975 A1
(43) Pub. Date: Aug. 22, 2013

(54) MESSAGING POLICY FOR A COMMUNICATION NODE

(71) Applicants: Johan Hjelm, Tokyo (JP); Olle Eriksson, Stockholm (SE)

(72) Inventors: Johan Hjelm, Tokyo (JP); Olle Eriksson, Stockholm (SE)

(73) Assignee: TELEFONAKTIEBOLAGET LM ERICSSON (publ), Stockholm (SE)

(21) Appl. No.: 13/825,426

(22) PCT Filed: Sep. 21, 2010
(86) PCT No.: PCT/EP2010/063885

§ 371 Date: Apr. 23, 2013

(51) Int. Cl. H04L 29/06

(52) U.S. Cl. CPC H04L 65/40
USPC 709/204

(57) ABSTRACT

There is provided a method in a node of a communication network. The method comprises establishing communication with a device, selecting a message according to a node profile, sending the selected message to the device; and updating the node profile according to the behavior of the device.

### TECHNICAL FIELD

The present application relates to a node in a communication network, a method in such a node, and a computer-readable medium.

### BACKGROUND

In the Open Mobile Alliance, OMA, there is currently activity to standardize mobile advertising. Mobile advertising is a technology for delivery of unsolicited and/or solicited commercial messages to mobile phones. Current standards define how to either deliver messages to individual mobile phones, or to all mobile phones within the coverage of e.g. a particular cell (using broadcast/multicast technologies). Multicast and cell broadcast technologies are described in 3GPP TS 03.41: Technical Realization of Short Message Service Cell Broadcast (SMSCB), and TS 23.041: Technical realization of Cell Broadcast Service (CBS), both of which are incorporated herein by reference.

A strength of mobile advertising is the ability to target messages at particular users according to their preferences. These preferences may be input by the user themselves and stored in a central database. However, user preferences of this kind may be proprietary information of the network operator and so not readily available to third parties because of regulatory or commercial reasons. Accordingly, targeted messages are predominantly distributed centrally by a network operator or their agent to all users in a network having a particular set of preferences.

### SUMMARY

According to the present application, there is provided a method in a node of a communications network. The method comprises establishing communication with a device, selecting a message according to a node profile, sending the selected message to the device; and updating the node profile according to the behavior of the device.

This allows for the collecting and aggregating of users' predilections, e.g. for the purpose of targeted messaging, from users visiting a specific micro-location or taking part in the activity at a specific micro-location, e.g. a restaurant or a sporting event. This is based on the principle that people that frequent the same location will likely share some interests, but in the absence of reviewing personal information from each user, the connection may not immediately be apparent.

Consider an American themed restaurant as an example; the above disclosed system and method may be utilized as follows. As a user enters, an advertising message is sent to his mobile device for all things American: Chevy trucks, cowboy boots, Harley Davidson perfume, snake oil, etc. Now assume that this restaurant is frequented by country fans. They do not like rock music, and prefer Jack Daniels to J&B. Over time, their acceptance or not of these ads and/or offers would result in ads for Skyy Vodka, Canada Goose jackets, and Bombardier snowmobiles being filtered out, bringing the profile for the location closer to the interests of the group. This is done without collecting any personal information from the users, merely by detecting their responses, or lack thereof, to messages sent to them.

The communication network may be a cellular communication system such as GSM, 3G, or LTE, or any other wireless communication system such as WiFi, Bluetooth, or Near Field Communication. The node of the communication network may be: a cell; a pico-cell; a WiFi access point; or a Bluetooth access point. The communication range of the node may define a location. The node may determine that the device is in communication with the network node if the device is detected as within communication range. For example, a restaurant may set up a pico-cell to cover its customer area, and one or more temporary cells may be set up to provide network coverage to users at a sporting event.

The selection of a message according to the node profile may comprise modifying the content of a message according to the node profile.

The device may send a reply in response to the message sent by the node, the reply giving an indication of a user's predilections. The node profile may be updated if no reply is received from a device within a timeout period. The node profile may comprise an aggregation of users' predilections for users that have visited the location. Predilections are similar to preferences and there may be significant overlap between the two. Conventionally, preferences are actively set by a user. Here, the term predilections is used to make clear the inclusion of both actively set user preferences and user preferences derived by the system indirectly from a user's responses.

There is further provided a node in a communications network, the node comprising: a memory for storing a node profile; a processor arranged to select a message according to the node profile; and a transmitter arranged to send the selected message to a device in communication with the network node. The processor is further arranged to update the node profile according to the behavior of the device.

There is further provided a computer-readable medium, carrying instructions, which, when executed by computer logic, causes said computer logic to carry out any of the above described methods.

### BRIEF DESCRIPTION OF THE DRAWINGS

A messaging policy for a communication node will now be described, by way of example only, with reference to the accompanying drawings, in which:

FIG. 1 shows an example system;

FIG. 2 is a signaling diagram for the system of FIG. 1; and

FIG. 3 is a flow diagram illustrating a method disclosed herein.

### DETAILED DESCRIPTION

Consider the example of a big chain of hamburger restaurants. The restaurant chain decides to make an offer to its customers using an electronic coupon. It would be wasteful of network resources to provide coupons to any potential customer, that is, every user of the wireless communications network. Therefore the coupons are only generated when they are needed.

To do this, a function is created which sends a message to the devices of users entering the premises of the hamburger restaurants, the message offering them a coupon. The coupon is generated and sent to the user's device if the user accepts the coupon offered to them in the initial message.

The messages offering the coupons are centrally controlled, by the head office of the chain of restaurants for example. Feedback can be obtained by the mechanism that requires the users to accept the offer of a coupon before it is sent to them. This allows information to be obtained regarding the percentage of customers who were exposed to an offer, and what the take-up rate of that offer was.

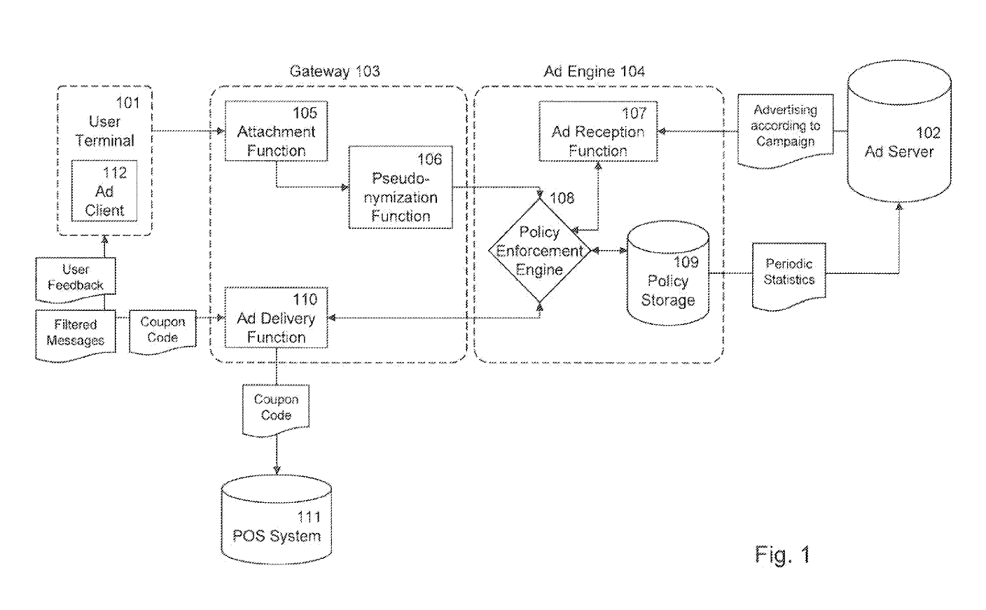

The above can be achieved by the system disclosed herein, an example of which is shown in FIG. 1. The example system comprises a user terminal 101, which includes an Ad client 112. The example system further comprises a gateway 103, an Ad engine 104, an Ad server 102 and a Point-of-Sale (POS) system 111. The gateway 103 comprises an attachment function 105, a pseudonymization function 106, and an Ad delivery function 110. The Ad engine 104 comprises an Ad reception function 107, a policy enforcement engine 108, and a policy storage 109.

The user terminal 101 is a mobile phone, personal digital assistant (PDA), portable media player (PMP) or similar. It does not have to have connectivity to a cellular wireless network, connection to a local network such as WiFi is sufficient.

The Ad server 102 is an implementation of an OMA MobAd server. As in the OMA MobAd standard, each advertisement is assumed to be characterized by a metadata object, which contains a description of relevant parameters regarding the advertisement. These parameters can be content classification (beer, women's underwear, etc); device capability requirements (screen size, codecs required, etc); demographic parameters (if available); number of times displayed, etc.

Gateway 103 is an application-level gateway, which also utilizes some network-level functionality. It can potentially be co-deployed with a network-level gateway.

Ad Engine 104 is at least partially an implementation of the OMA MobAd Ad Engine, although its functionality is richer.

Attachment Function 105 registers the users attachment to the micro-location.

Pseudonymization Function 106 generates a session key for the User Terminal 101 which is applied to all transactions instead of the actual user identity or network identity.

Ad Reception Function 107 receives the advertisements from the Ad Server 102 and provides them to a Policy Enforcement Engine 108.

The Policy Enforcement Engine 108 performs filtering of advertisements based on aggregated policy and advertising metadata. As the interactions of the users relating to specific types of advertisements are aggregated, they will comprise a compound policy for the users visiting the specific micro-location, and this gradually constructed policy can be used to filter in advertising which is relevant to all users who frequents the specific micro-location. This, in turn, can be leveraged in sales towards this community, which will lead to higher fulfillment rates.

The Policy Storage 109 stores the policies used by the Policy Enforcement Engine 108. These policies can be gradually generated by the Policy Enforcement Engine 108 as described below and/or they can be provided by an external party, for instance a network operator or the head office of the chain of restaurants.

Ad Delivery Function 110 performs two functions: Push of advertisements to an Ad Client 112 in the user terminal 101 (using MobAd protocols, for instance OMA Push, or the equivalent); and it calculates the coupon codes which are used in the user interaction should the user accept the offered coupon.

POS System 111 is the Point-of-Sale system of a particular hamburger restaurant in the chain. It is a standard cash register, and communicates with the Ad Delivery Function 110 to verify the coupon code provided from the user terminal 101 during redemption of the coupon.

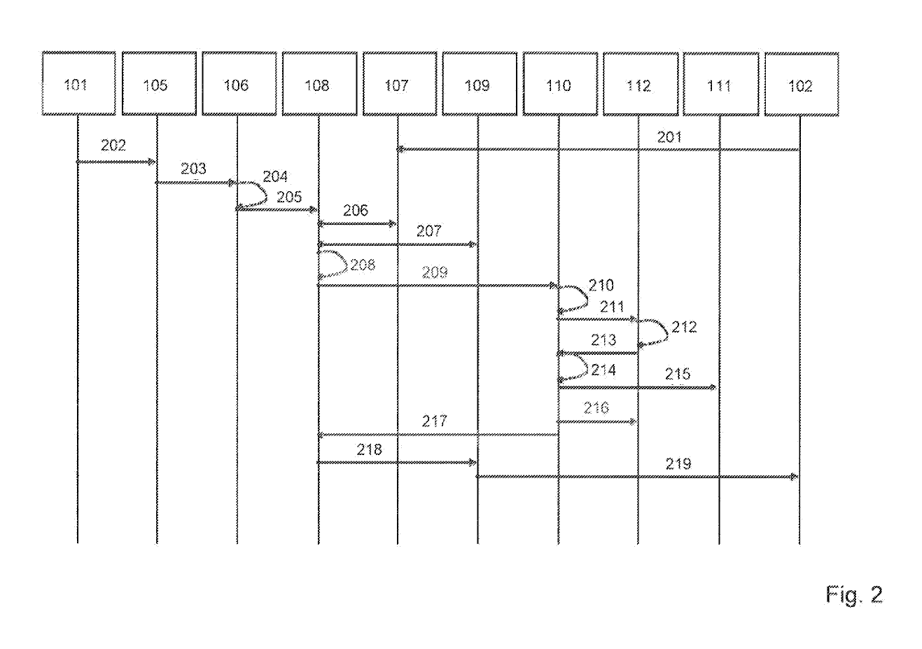

The operation of the example system of FIG. 1 will now be described also with reference to the signaling diagram of FIG. 2.

201: The Ad Server 102 delivers advertisement messages, structured according to a campaign, to the Ad Reception Function 107 of the Advertising Engine 104. Although not shown, the provisioning of policies into the Policy Storage 109 of the Ad engine 104 may occur at the same time, and potentially from the same source.

202: User terminal 101 attaches to the short-range network of the gateway 103 through the attachment function 105. This takes place using known means, for instance using Bluetooth, WiFi, RFID, NFC, or other means. For a hamburger or coffee house chain that provides free wireless internet to customers, this is a convenient way of re-using the already installed systems. However, the mechanism of detecting the presence of a user device and sending it a message can also be fulfilled by the user's device being used to photograph a 2 dimensional bar code such as a QR-code (Quick Response) and thus delivering a message, which may trigger an attachment. Thus a user device at the micro-location can receive a message without connecting to a local network. Where a connection to a local network is made, this connection does not have to be physical, and can be determined by proximity derived from the network position of the device. Further, it is assumed that the attachment includes means of receiving the capabilities of the device, specifically the capability to receive push messages and what means it has to display such messages.

203: The attachment of user terminal 101 to gateway 103 triggers the operation of pseudonymization function 106. 204: Pseudonymization function 106 generates a session key for the user terminal 101. 205: The session key and any discovered capabilities are sent to the Policy Enforcement Engine 108 of the Ad engine 104.

206: The Policy Enforcement Engine 108 retrieves the available advertisements from Advertisement Reception Function 107. 207: The Policy Enforcement Engine 108 retrieves the current policy from the Policy Storage 109. Policy Enforcement Engine 108 applies the retrieved policy to the retrieved advertisements, filtering out those advertisements which are not desirable to the audience frequenting the restaurant. If this is the first time the process is applied, unless policies have been externally provisioned, the policy storage 109 is empty and no filtering will occur.

209: Selected advertisements are delivered to the Ad Delivery Function 110.

210: Ad Delivery Function 210 rewrites the address of the advertisements so that they point back to the Gateway 103. Here it is assumed that the delivery of advertisements occur using the Internet, in a mobile incarnation, so that the addressing of the Ad Delivery Function 110 and the User Terminal 101 are independent of the location. No data delivery occurs over the local network used by the attachment function 105.

211: The Ad Delivery Function 110 pushes the advertisements to the Ad Client 112 in the user terminal 101 (using the OMA MobAd specification or other suitable means).

212: The user device provides feedback, for instance the user of the device may accept the coupon offer provided as part of the advertisement message.

213: Ad Client 112 returns the feedback to the Ad Delivery Function 110.

214: Ad Delivery Function 110 generates a coupon code based on the session key of the User Terminal 101. The coupon code will be unique for the current transaction.

215: Ad Delivery Function 110 sends the coupon code to the POS System 111.

216: Ad Delivery Function 110 sends the coupon code to the Ad Client 112. When the user redeems the coupon, the code sent to the POS System 111 is matched against the code sent to the Ad Client 112. This can be done by matching numerical codes, or it can be done by implementing a scannable barcode displayed on the device, or a code readable by RFID, or some other means. The matching may be performed at a point of sale terminal, or the coupon code from the Ad client L may be sent from the point-of-sale terminal to another part of the point-of-sale system for verification.

217: Ad Delivery Function 210 provides feedback about the transaction to the Policy Enforcement Engine 108. This feedback may comprise information about the coupon redeemed. This feedback may comprise an indication that the coupon offer was not accepted or the coupon offer was not redeemed prior to the expiry of a timeout period.

218: Policy Enforcement Engine 108 updates Policy Storage 109 with the feedback information. At this time, the current transaction is added to the policy stored in the Policy Storage 109 so that future transactions are refined according to the current user transactions, without explicit knowledge of the users identity, personal profile, or other private information. Over a series of transactions the policy storage 109 builds up a node profile which includes an aggregation of the predilections of users that have visited the micro-location. Thus, the Policy Enforcement Engine 108 can in this step update the policy stored in the Policy Storage 109 through a means which enhances the potential acceptance for advertisements. For example, if all coupons created are for kids meals, the filtering process can be updated to prioritize advertisements directed at parents in future outgoing messages.

219: The Policy Storage 109 periodically generates and sends statistics to the Ad Server 102, which can be used in improving future messaging campaigns.

The micro-location may be defined by the communication range of a node or a group of nodes in a wireless communications network. The micro-location could be, for example, the size of a restaurant or a football stadium.

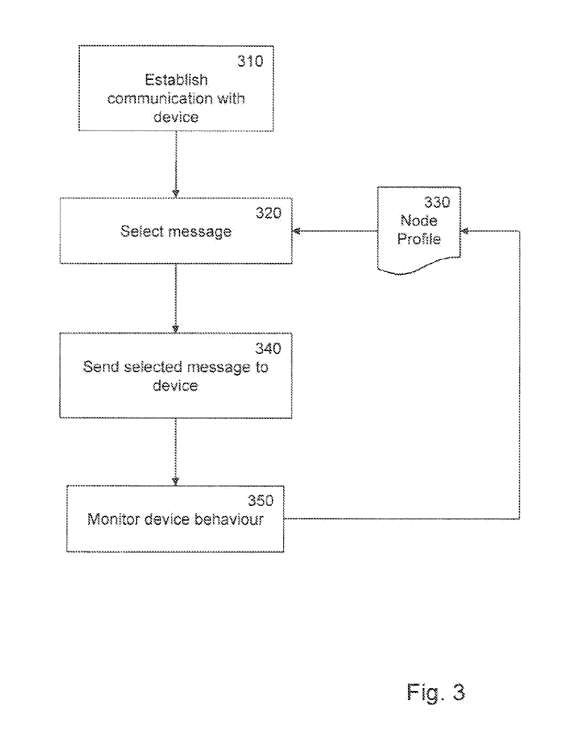

FIG. 3 illustrates a method embodied in a node 103,104 of a wireless communications network. At 310 the node 103,104 establishes communication with a device 101. At 320, the node 103,104 selects a message for sending to the device using a node profile 330. At 340 the node 103,104 sends the selected message to the device 101. At 350 the node 103,104 monitors the behavior of the device 101 and updates the node profile 330 accordingly.

It will be apparent to the skilled person that the exact order and content of the actions carried out in the method described herein may be altered according to the requirements of a particular set of execution parameters. Accordingly, the order in which actions are described and/or claimed is not to be construed as a strict limitation on order in which actions are to be performed.

Further, while examples have been given in the context of particular communications standards, these examples are not intended to be the limit of the communications standards to which the disclosed method and apparatus may be applied.

1. A method in a node of a communications network, the method comprising:
establishing communication with a device;
selecting a message according to a node profile;
sending the selected message to the device;
updating the node profile according to the behavior of the device.

2. The method of claim 1, wherein the node of the communication network is at least one of:
a cell;
a picocell;
a WiFi access point; and
a Bluetooth access point.

3. The method of claim 1 or 2, wherein the communication range of the node defines a location.

4. The method of any preceding claim, wherein the node determines that the device is in communication with the node if the device is detected as within communication range.

5. The method of any preceding claim, wherein the selection of a message according to the node profile comprises modifying the content of a message according to the node profile.

6. The method of any preceding claim, wherein the device sends a reply in response to the message, the reply giving an indication of a user's predilections.

7. The method of any preceding claim, wherein the node profile is updated if no reply is received from a device within a timeout period.

8. The method of claim 6 or 7, wherein the node profile comprises an aggregation of users' predilections for users that have visited the location.

9. A node in a communications network, the node comprising:
a memory for storing a node profile;
a processor arranged to select a message according to the node profile; and
a transmitter arranged to send the selected message to a device in communication with the network node;
wherein the processor is further arranged to update the node profile according to the behavior of the device.

10. The node of claim 9, wherein the node is at least one of:
a cell;
a picocell;
a WiFi access point; and
a Bluetooth access point.

11. The node of claim 9 or 10, wherein the communication range of the node defines a location.

12. The node of claim 9, 10 or 11, wherein an attachment function determines that the device is in communication with the node if the device is detected as within communication range.

13. The node of any of claims 9 to 12, wherein the selection of a message according to the node profile comprises modifying the content of a message according to the node profile.

14. The node of any of claims 9 to 13, wherein the reply received from the device gives an indication of a user's predilections.

15. The node of any of claims 9 to 14, wherein the node profile is updated if no reply is received from a device within a timeout period.

16. The node of claim 14 or 15, wherein the node profile comprises an aggregation of users' predilections for users that have visited the location.

17. A computer-readable medium, carrying instructions, which, when executed by computer logic, causes said computer logic to carry out any of the methods defined by claims 1 to 8.
